(19) United States
(12) Patent Application Publication
(10) Pub. No.: US 2012/0104190 A1
(43) Pub. Date: May 3, 2012

(54) SUPPORT POLE WITH A PREFABRICATED ENGAGING THREAD AND METHOD OF USING THE SAME

(76) Inventor: Richard Parent, Ingleside, IL (US)

(21) Appl. No.: 13/103,183

(22) Filed: May 9, 2011

Related U.S. Application Data
(60) Provisional application No. 61/408,286, filed on Oct. 29, 2010.

(51) Int. Cl. F16M 11/04; F16M 11/22

(52) U.S. Cl. 248/121; 248/156

(57) ABSTRACT

The present invention generally relates to a support pole with a prefabricated engaging thread and method of using the same. The support pole is especially suitable for use with mailbox posts, birdhouse posts, volleyball posts, fences, or the like. The support pole may be securely inserted or removed from the ground without the need for tools. The support pole has an extended arm that extends in a substantially perpendicular manner with respect to the pole. The extended arm allows a user to apply a force perpendicular to the main support pole so as to help the user rotate the pole and therein force the pole into the ground.

### REFERENCE TO RELATED APPLICATIONS

The present application is based on U.S. provisional application No. 61/408,286 filed on Oct. 29, 2010, currently co-pending, the entire contents of which are incorporated by reference. Applicant claims the priority benefit of the '286 application.

### BACKGROUND OF THE INVENTION

The present invention generally relates to a support pole with a prefabricated engaging thread and method of using the same. The support pole is especially suitable for use with mailbox posts, birdhouse posts, volleyball posts, fences, or the like. The support pole may be securely inserted or removed from the ground without the need for tools. The support pole has an extended arm that extends in a substantially perpendicular manner with respect to the pole. The extended arm allows a user to apply a force perpendicular to the main support pole so as to help the user rotate the pole and therein force the pole into the ground.

Over the years, numerous devices and methods have been developed to secure a pole in the ground. For example, U.S. Pat. No. 7,438,273 to Tota discloses an anchor for securing an object to the ground. The anchor is especially useful for securing, either temporarily or permanently, fixing objects to the ground, such as signs, poles, mailbox posts, tent or net supports. Placement of the device requires no digging and few or no tools, and visible damage to the landscape is reduced. Advantageously, subterranean obstructions can be detected and avoided while securing the device to the ground, thereby protecting utility lines from damage. Typically, little strength and low torque is needed to secure the anchor to the ground.

Further, U.S. Pat. No. 7,175,141 to Bolinder discloses a removable sign support system for supporting a sign on the ground which includes a substantially upright support post, configured to removably receive a sign post. The support post has a substantially horizontal base affixed to its bottom end, with a plurality of spikes downwardly extending from the base into the ground, and a lifting connection fixedly attached to the support post. A removal device is provided for removing the support post from the ground, and includes a moveable column having a bottom end configured to bear upon the top of the ground near the base of the support post, and a lever arm pivotally attached to the moveable column. The removal device is configured to pull the spikes upwardly out of the ground by engaging the lever arm with the lifting connection and applying a substantially upward force thereon.

However, these support poles fail to disclose a support pole that has a permanently secured digging mechanism, which allows for easy insertion of the support pole into the ground. A need, therefore, exists for an improved support pole for use in connection with securing poles into the ground.

### SUMMARY OF THE INVENTION

The present invention generally relates to a support pole with a prefabricated engaging thread and method of using the same. The support pole is especially suitable for use with mailbox posts, birdhouse posts, volleyball posts, fences, or the like. The support pole may be securely inserted or removed from the ground without the need for tools. The support pole has an extended arm that extends in a substantially perpendicular manner with respect to the pole. The extended arm allows a user to apply a force perpendicular to the main support pole so as to help the user rotate the pole and therein force the pole into the ground.

An advantage of the present support pole and method of using the same is that the support pole does not require pre-digging.

Yet another advantage of the present support pole and method of using the same is that little torque is needed to twist the pole and secure the pole into the ground.

An advantage of the present support pole and method of using the same is that the support pole does not need any tools to insert the support pole into the ground.

Yet another advantage of the present support pole and method of using the same is that the user may easily transport and store the support pole.

Still another advantage of the present support pole and method of using the same is that the user may easily remove the pole from the ground and insert the pole in an alternative location.

And another advantage of the present support pole and method of using the same is that the user may change the items secured to the pole, such as mailboxes, birdhouses, house signs, etc.

Still further, an advantage is that the support pole may have a plurality of vertical ridges that provide additional strength to the pole.

And another advantage of the present support pole is that the device may have a reflective paint which allows for easy visibility of the support pole in diminished light.

For a more complete understanding of the above listed features and advantages of the support pole with a prefabricated engaging thread reference should be made to the following detailed description of the preferred embodiments and to the accompanying drawings.

### BRIEF DESCRIPTION OF THE DRAWING

FIG. 1 illustrates a front perspective view of the support pole with a prefabricated engaging thread.

FIG. 2 illustrates a side plan view of the support pole with a prefabricated engaging thread.

FIG. 3 illustrates a front plan view of the support pole with a prefabricated engaging thread.

FIG. 4 illustrates a side plan view of the support pole with a prefabricated engaging thread.

FIG. 5 illustrates a top plan view of the support pole with a prefabricated engaging thread.

FIG. 6 illustrates a bottom plan view of the support pole with a prefabricated engaging thread.

FIG. 7 illustrates a back plan view of the support pole with a prefabricated engaging thread.

FIG. 8 illustrates a side of the support pole with a prefabricated engaging thread being inserted into the ground.

FIG. 9 illustrates an interior view of the main pole with the top removed.

FIG. 10 illustrates a cross sectional close up of the engaging thread of the support pole.

### DETAILED DESCRIPTION OF THE PREFERRED EMBODIMENTS

The present invention generally relates to a support pole with a prefabricated engaging thread and method of using the same. The support pole is especially suitable for use with mailbox posts, birdhouse posts, volleyball posts, fences, or the like. The support pole may be securely inserted or removed from the ground without the need for tools. The support pole has an extended arm that extends in a substantially perpendicular manner with respect to the pole. The extended arm allows a user to apply a force perpendicular to the main support pole so as to help the user rotate the pole and therein force the pole into the ground.

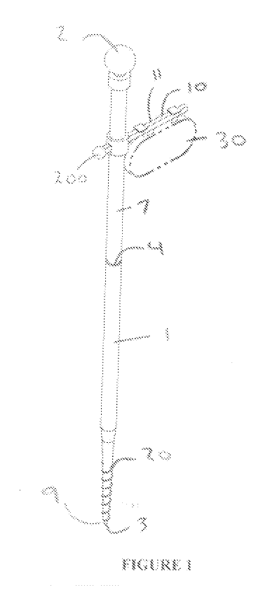

Referring now to FIG. 1, the support pole 1 may have a top 2, a bottom 3, and a circumference 4. The support pole 1 may also have an interior 6 (FIG. 9) and an exterior 7. The support pole 1 may be largely constructed from metal, plastic, or the like. Preferably, the support pole 1 may be strong enough to stand up to the elements and may also be strong enough to be able to displace dirt while being inserted into the ground.

The bottom end 3 of the support pole 1 may have a sharpened tip 9. The sharpened tip 9 may be suitable for breaking into the ground. Further, near the bottom 3 of the support pole 1 may be an engaging thread 20 that runs around the external surface 7 of the pole 1. The engaging thread 20 may help to displace dirt as the pole 1 is inserted into the ground. Further, the engaging thread 20 may provide additional surface area which contacts the ground, which may increase the stability of the pole 1 while the bottom portion of the pole 1 is inserted in the ground. The engaging thread 20 may run at approximately a ten to twenty degree angle with respect to the ground.

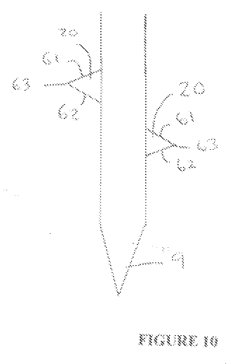

Referring now to FIG. 10, the engaging thread 20 of the support pole 1 may be two-sided such that the threads 20 compact the soil so that the support pole 1 may be inserted into the ground in a stronger, more studier fashion. More specifically, the engaging thread 20 of the present support pole 1 may have a first side 61, a second side 62 and a central ridge 63. The first side 61 may face upward, toward the top 2 of the support pole 1 while the second side 62 faces downward toward the bottom 3 of the support pole 1. The first side 61 may be largely identical to the second side 62 except for the direction each side faces. The first side 61 and the second side 62 may meet at and form the central ridge 63. The first side 61 may angle approximately forty-five to sixty-five degrees with respect to the support pole 1 while the second side also may angle approximately forty-five to sixty-five degrees with respect to the support pole 1 (although in the opposite direction). Typically, a screw would have a thread wherein one side of the thread is angled less than ninety degrees with respect to a central shaft while the second side is angled greater than ninety degrees with respect to the shaft. As a result, a typical screw thread is substantially flat wherein the engaging thread 20 of the present device 1 is a largely symmetrical engaging thread 20.

The interior 6 of the support pole 1 may not be visible through the exterior 7 of the support pole 1. The interior 6 of the support pole 1 may be hollow and may be constructed from a material different from the exterior surface 7, or the interior 6 may be constructed uniformly with the exterior 7 of the support pole 1.

The support pole 1 may further have an extended arm portion 10 having a top 11. The extended arm portion 10 may extended substantially perpendicular with respect to the main body of the pole 1.

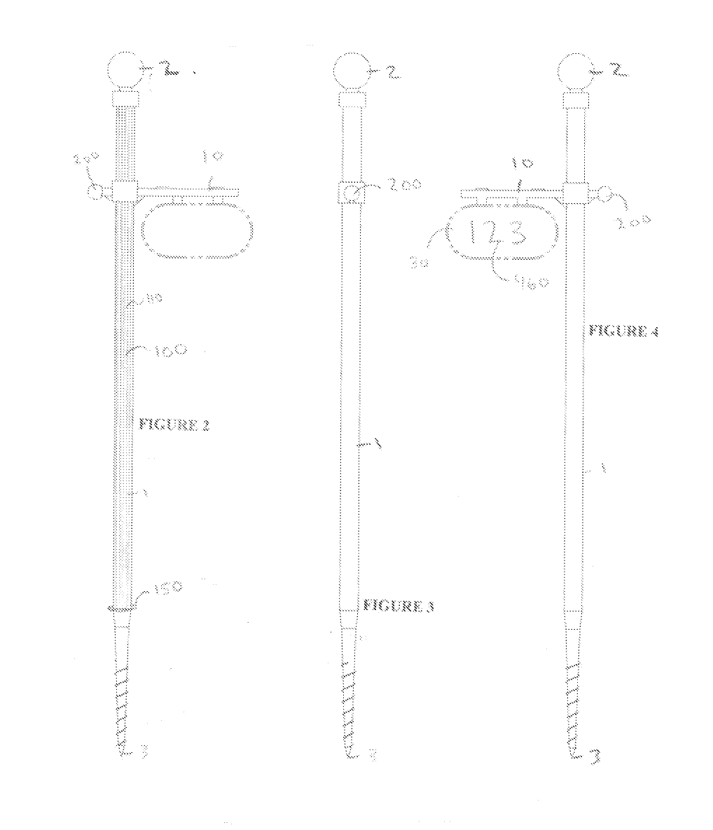

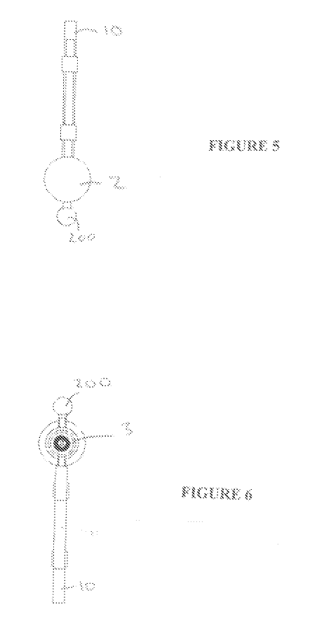

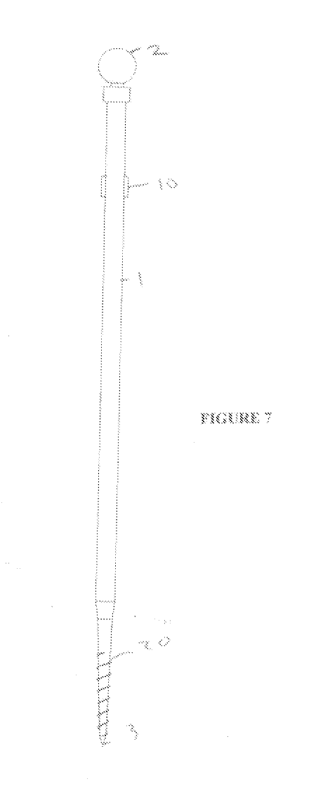

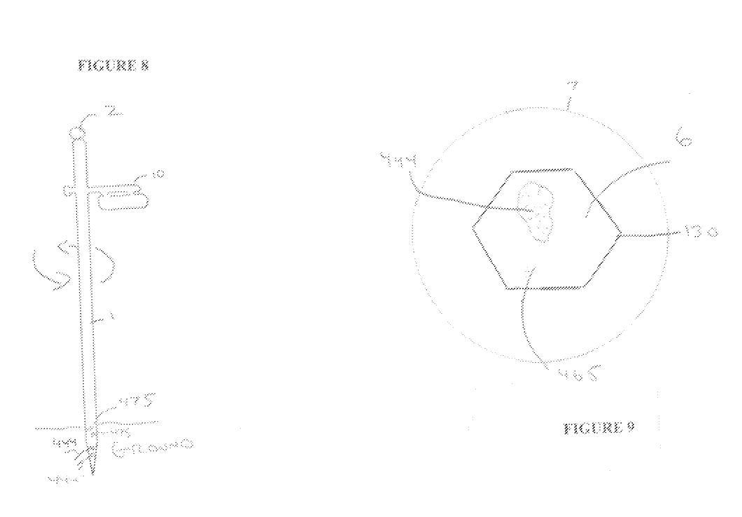

In an embodiment (FIG. 2), the exterior surface 7 of the support pole 1 may further have a plurality of ridges 100. The plurality of ridges 100 may extend vertically from substantially the top 2 of the pole 1 toward the bottom 3 of the pole 1. The plurality of ridges 100 may be parallel with respect to one another. The plurality of ridges 100 may not only be ornamentally pleasing, but may also help prevent the pole 1 from unintentionally shifting when inserted into the ground. More specifically, the ridges 100 may provide additional surface area (near the bottom portion of the support pole 1) which may come into direct contact with the ground; therein helping reduce possible shifting of the pole with respect to the ground once the support pole 1 is secured in the ground. Further, the plurality of ridges 100 may provide additional surface area and additional angles wherein a reflective paint 110 may increase the chances of a motorist being able to see the pole 1 in diminished light.

The plurality of ridges 100 may also reduce the appearance of scratches or marks that otherwise would appear on a support pole 1 with a smooth exterior surface 7 over time. As a result, reducing the appearance of scratches and marks also allow for the reflective paint 110 to remain on the exterior surface 7 therein increasing visibility of the support pole 1 and safety. Still further, the plurality of ridges 100 increases the strength of the support pole 1 and reduces possible damage by a side impact of a vehicle with the support pole 1.

To insert the support pole 1 into the ground, the user may electively first wet the ground with water so as to soften the dirt in the ground. The user may then place the sharpened tip 9 of the bottom end 3 of the support pole 1 over the spot wherein the user wishes the support pole 1 to be placed. With a downward and twisting force, the user then screws the support pole 1 into the ground. A benefit of the device 1 is that minimal torque is required to secure the support pole 1 into the ground. Further, the support pole 1 does not require the pre-digging of a hole prior to insertion of the support pole 1 into the ground.

The user may grasp the support pole 1 while twisting the support pole 1 into the ground. In addition to grasping the main body of the support pole 1, the user may also gain leverage and force by grasping the extended arm 10 of the support pole 1 and a ball 200 portion (defined below). A user may also lean on the support pole to apply a downward pressure while securing the support pole 1 into the ground. A user may insert the pole 1 into the ground without the need for any tools.

In an embodiment, a ball portion 200 may extend outward from the main body of the support pole 1. The ball 200 may extend opposite the extended arm 10 and along the same planar axis. The ball 200 may provide a counter-weight and may help balance the extended arm 10 and, for example, a mailbox, which may be located on top 11 of the extended arm 10. More specifically, the ball portion 200 may have substantially the same weight as the extended arm 10 portion so as to counter-balance the entire pole 1. In addition, the ball 200 may allow a user to evenly apply pressure to both sides of the support pole 1 while the support pole 1 is being inserted or removed from the ground. The curved shape of the ball 200 may allow the user to grasp the support pole 1 by hand without grasping any sharp edges; therein allowing the user to more easily rotate the support pole 1 during insertion or removal of the support pole 1.

Referring now to FIG. 9, in an embodiment, the interior 6 of the support pole 1 may have a hexagonal configuration 130. The hexagonal configuration 130 of the support pole 1 may help provide interior strength by increasing the thickness of the interior of the support pole 1 over a basic hollow interior. Further, the hexagonal configuration 130 of the interior 6 may also allow a user to insert a tool, such as a large allen wrench, into the interior 6 (at the top 2) so as to rotate the support pole 1 and/or secure an ornamental covering over the top 2 of the device 1.

In an embodiment, the very top 2 (as illustrated by a ball in the figures) of the pole 1 may be removed and a hole 465 under the top 2 of the pole 1 may allow, for example, concrete 444 or sand to be poured down into the interior 6 of the pole 1, through the hexagonal configuration 130. The top 2 may then be replaced. Placing concrete 444 or sand in the interior 6 of the pole 1 may provide weight and/or stability for the pole 1 while the support pole 1 is secured within the ground. Further, in an embodiment, a plurality of smaller holes 475 (FIG. 8) may be located near the bottom 3 of the device 1. The plurality of the smaller holes 475 near the bottom 3 of the device may allow, for example, concrete 444 to partially escape from the interior 6 of the pole 1 while concrete 444 is being poured into the interior 6 of the pole 1 while the pole 1 is newly inserted into the ground. More specifically, while pouring concrete 444 into the interior 6 of the pole 1 during the initial set up of the pole 1, some concrete 444 may escape the interior 6 of the pole 1 through the plurality of smaller holes 475 and therein create a bridge-anchor (from the interior to the exterior) to further secure the pole 1 within the ground; some of the concrete remaining within the interior 6 of the support pole 1 and some concrete escaping the interior 6 of the support pole 1.

In an embodiment, a single circular ridge 150 (FIG. 2) may surround the circumference 4 of the support pole 1 near the bottom of the pole 1. The circular ridge 150 may be horizontal and may run substantially perpendicular to the plurality of ridges 100 and body of the support pole 1. The circular ridge 150 may be located near the bottom 3 of the device 1 and may further serve to indicate the height-level at which the support pole 1 is recommended to be inserted into the ground. Further, the circular ridge 150 may provide additional surface area contacting the ground to the support pole 1 and may help maintain the support pole 1 in an upright and vertical position with respect to the ground.

The circular ridge 150 may also be used as a brace for a person to stand on while inserting the pole 1 into the ground; therein increasing the downward force while the support pole 1 is being inserted into the ground. In an embodiment, the pole 1 may be twisted enough such that the single circular ridge 150 may be actually moved underground while the support pole 1 is secured into the ground. As a result, a smaller percentage of the overall height of the support pole 1 may remain above-ground and the bottom of the plurality of ridges 100 may be partially located underground. As stated above, the support pole 1 may have an extended arm 10. Preferably, the extended arm 10 may extend outward at approximately ninety degrees with respect to the main body of the support pole 1. Accordingly, the extended arm 10 may remain largely parallel with respect to the ground and perpendicular with respect to the body of the support pole 1.

The extended arm portion 10 of the support pole 1 may be used to hang or otherwise secure a mailbox, birdfeeder, house sign, fence or the like. The figures illustrate a sign platform 30 being hung from the extended arm portion 10; however it should be understood that any suitable device may be secured to the extended arm portion 10 of the support pole 1. In an embodiment, a sign platform 30 may be magnetic so as to allow changeable signs or house numbers 460 to be attached and easily changed.

To remove the support pole 1 from the ground, the user may simply reverse the process in terms of the direction of the twist used to get the support pole 1 into the ground.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

1. A support pole having a prefabricated engaging thread comprising:
a generally cylindrical shaft having a top, a bottom and an exterior surface forming a circumference;
an engaging thread surrounding a portion of the bottom; and
an extended arm connected to and extended outward from the generally cylindrical shaft at approximately ninety degrees with respect to the generally cylindrical shaft and wherein the support pole is rotated to insert the engaging thread into the ground.

2. The support pole of claim 1 further comprising:
a generally planar surface attached to and located below the extended arm wherein the generally planar surface is located substantially perpendicular with respect to the generally cylindrical shaft.

3. The support pole of claim 2 wherein the generally planar surface is magnetic and wherein a magnetic sign, a magnetic number or a magnetic letter is temporarily secured to the generally planar surface.

4. The support pole of claim 1 further comprising:
a plurality ridges on the exterior surface of the generally cylindrical shaft wherein the plurality of ridges run substantially parallel with respect o the generally cylindrical shaft and with respect to each other wherein the plurality of ridges increases the surface area of the exterior surface of the generally cylindrical shaft.

5. The support pole of claim 1 further comprising:
a first side of the engaging thread;
a second side of the engaging thread;
a central ridge wherein the first side of the engaging thread and the second side of the engaging thread meet wherein the first side of the engaging thread is substantially identical to the second side of the engaging thread and wherein the first side of the engaging thread is at an angle substantially identical with respect to the bottom portion of the generally cylindrical shaft as the angle of the second side of the engaging thread with respect to the bottom portion of the generally cylindrical shaft.

6. The support pole of claim 1 further comprising:
a reflective paint applied to the exterior surface.

7. The support pole of claim 1 further comprising:
a plurality of holes located substantially near the bottom or the generally cylindrical shaft wherein concrete or sand poured into an interior of the generally cylindrical shaft at the top of the generally cylindrical shaft partially escapes the interior of the generally cylindrical shaft through the holes at the bottom of the generally cylindrical shaft and anchors the generally cylindrical shaft into the ground.

8. The support pole of claim 1 further comprising:
a counter-weight located on the generally cylindrical shaft substantially opposite of the extended arm of the support pole wherein the counter-weight and the extended arm are on the same axis.
